(19) United States
(12) Patent Application Publication
(10) Pub. No.: US 2013/0067908 A1
(43) Pub. Date: Mar. 21, 2013

(54) PERFECTED ROTATIONAL ACTUATOR

(71) Applicants: Simone Pittaccio, Milano (IT); Stefano Viscuso, Cavallasca-Como (IT); Stefano Besseghini, Tirano-Sondrio (IT)

(72) Inventors: Simone Pittaccio, Milano (IT); Stefano Viscuso, Cavallasca-Como (IT); Stefano Besseghini, Tirano-Sondrio (IT)

(73) Assignee: CONSIGLIO NAZIONALE DELLE RICERCHE, ROMA (IT)

(21) Appl. No.: 13/696,289

(22) PCT Filed: May 10, 2011
(86) PCT No.: PCT/EP2011/002385

§ 371 Date: Nov. 5, 2012

(30) Foreign Application Priority Data
May 14, 2010 (IT) MI2010A000859

(51) Int. Cl. F03G 7/06

(52) U.S. Cl. CPC F03G 7/065
USPC 60/528

(57) ABSTRACT

A perfected rotational actuator, comprising, in two box-shaped shells (31, 32), a pair of plates (12, 13) connected to each other by a central pin (14) and containing, between the same, a plurality of pulleys (25), with two superimposed perimetric slots (29), in which a shape memory alloy wire (21) circulates, wherein two segments of said wire (21) are arranged in aligned slots (29) of the pulleys (25) and are constrained at opposite ends to non-conductive elements (19) integral with a tooth (16) protruding radially from a plate (12) and in a position shifted by a certain angle (θ) with respect to each other, the two segments of wire being defined by passage through a further non-conductive element (20) integral with a tooth (17) radially protruding from the second plate (13), a torque spring (23) situated on the central pin (14) being interposed between the plates (12, 13), the opposite ends of the wire (21) being connected to an electric wire (22), radial arms (34, 35) of each of the shells (31, 32) being connected to elements to which the rotation movement is to be transmitted.

The present invention relates to a perfected rotational actuator.

In the field of actuators, applications exist in which filiform or strap-like metal elements are used, which have a shape memory, called SMA (shape memory alloys).

In this field of the art, the production of a rotational actuator with SMA shape memory alloys generally comprises the use of springs or tubes or bars made of SMA material, subjected to torsion which, once heated, recover their shape and effect an operation. Solutions of this type are described in U.S. Pat. No. 4,010,455, U.S. Pat. No. 4,798,051, U.S. Pat. No. 5,127,228, U.S. Pat. No. 5,396,769, U.S. Pat. No. 5,975,468, U.S. Pat. No. 6,065,934, U.S. Pat. No. 6,129,181 and U.S. Pat. No. 6,484,848.

Alternatively, windings of shape memory alloy wires which generate rotation as they are attached to the edge of a movable element which can rotate at the centre, are described in U.S. Pat. No. 4,275,561, U.S. Pat. No. 4,472,939, U.S. Pat. No. 4,544,988, U.S. Pat. No. 4,761,955, U.S. Pat. No. 4,965,545, U.S. Pat. No. 6,746,552, U.S. Pat. No. 6,832,477 and U.S. Pat. No. 7,021,055.

It is known that the passive movement of the limbs can be used in medicine for various purposes, among which exercise aimed at maintaining the viscoelastic characteristics of the tissues and providing somatosensory and proprioceptive stimulation; supporting active exercise in the initial phases of functional recovery from a paresis; other uses, also non-clinical, among which neurophysiological studies.

Motorial rehabilitation following neurological, traumatic or orthopaedic injury, can avail of the passive movement of limbs and articulations as an aid for preventing a prolonged immobility and disuse of the paretic segments from causing chronic consequences with a serious impact on the patient's life.

Passive exercise can be administered both through the hands of a physiotherapist and with robotic means. This often means that important resources in terms of time and equipment must be spent on the part of the clinical structures which house the patient.

In view of what is stated above, it is evident that the use of a light and transportable device, which can be carried and potentially used at the patient's home, could solve some of the organizational and operational problems which the prescription of passive physiotherapy implies.

Similarly, also during the gradual functional recovery of the patient, there is often the necessity of prolonging active exercise sessions for as long as possible.

This means that it is beneficial to avail of technological solutions which can make the patient as independent as possible during the exercise. Consequently a device which is easy to carry and use at home would represent an important contribution to giving the patient the possibility of intensifying his/her rehabilitation. Furthermore, considering that in the first recovery phases of the voluntary control of the muscles, the subject may not have sufficient strength to complete the movement prescribed as exercise, an active device which increases voluntary motorial exertion could favour a precocious start of the active rehabilitation phase with a consequent improved prognosis with respect to a functional recovery.

The voluntary control of the limbs is in fact based on the activation of the muscles according to schemes controlled by more or less specific areas of the cerebral cortex. These areas are capable of both initiating movement and also controlling its exertion by referring to sensorial information relating to the positions acquired by the limb in movement and the inner and external forces exchanged by this. Also during passive movement, a great deal of information of this type reaches the brain and it is important for neuroscience to understand firstly how this influences the activation of the cerebral cortex and also if a continuous exposure of the neuro-injured patient to sensorial stimuli on the movement can be significant for favouring a reacquisition of the motorial capacities. In neuroscience the common praxis requires making various registrations of the cerebral signal synchronized with the stimulus and mediating them with each other, in order to improve the signal/noise ratio and enable the extraction of significant characteristics from the cerebral activity. This implies that, in order to have the maximum repeatability, tactile stimuli or movements imposed upon the limbs should not be administered manually by an operator, as this would create a disturbance element which would confuse the results.

The use of motors would allow the movement to be standardized, but the diagnostic techniques adopted in neuroscience (magnetoencephalography—MEG, functional magnetic resonance—fMRI . . . ) generally have considerable restrictions of electromagnetic compatibility which the most common motors, among which electric motors in particular, cannot overcome.

In order to solve the technical problems of lightness and transportability, adaptation to the changing capacities of the recovering patient in exercising and magnetic transparency to allow neuro-scientific research, a solution must be found which surmounts the known art indicated above for these aspects.

A general objective of the present invention is to solve all of the above drawbacks mentioned above of the known art in an extremely simple, economical and particular functional manner.

A further objective is to provide a rotational actuator which is easy to apply and compatible for applications in which there must be no interferences of a magnetic type.

In view of the above objectives, according to the present invention, a perfected rotational actuator having the characteristics specified in the enclosed claims has been conceived.

The structural and functional characteristics of the present invention and its advantages with respect to the known art will appear even more evident from the following description referring to the enclosed drawings, which, among other things, show some embodiments of rotational actuators according to the invention.

In the drawings:

FIG. 1 is an exploded schematic perspective view of a rotational actuator according to the present invention;

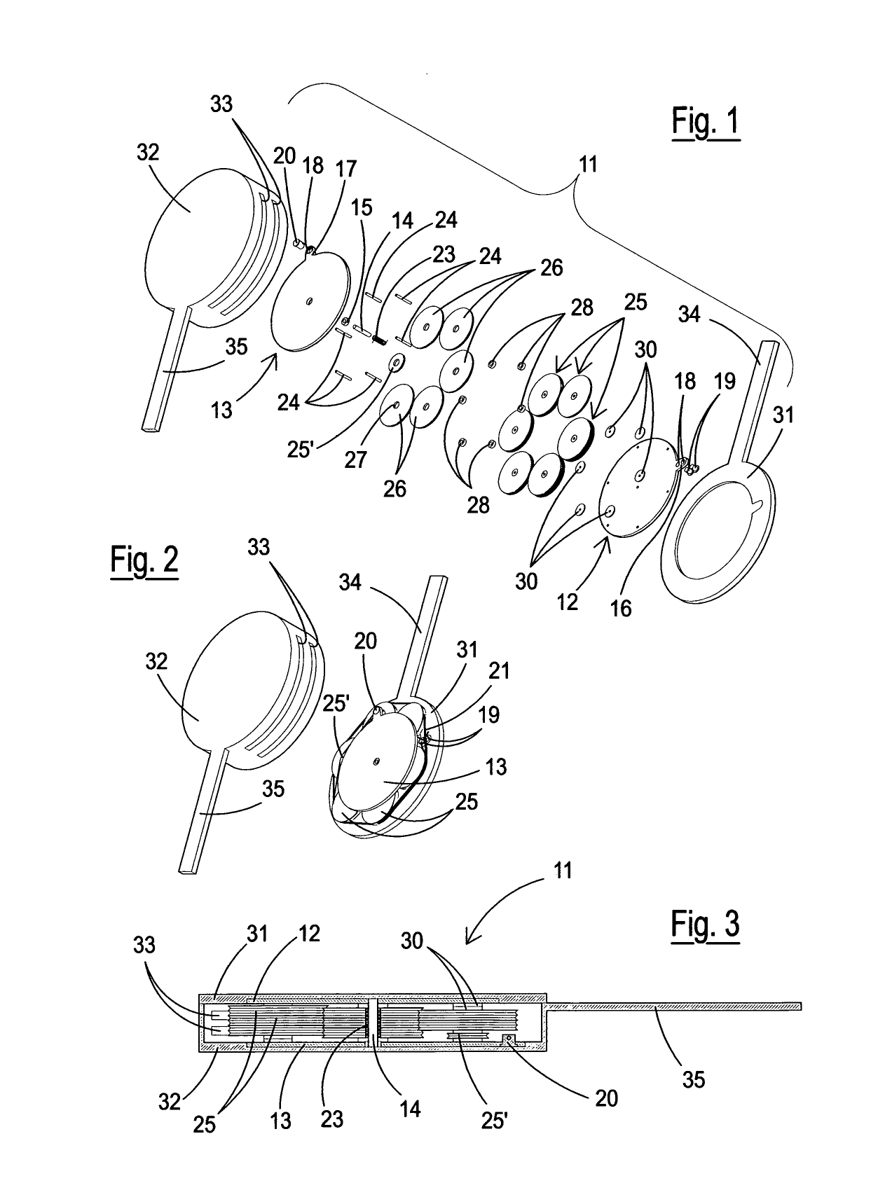

FIG. 2 is a further perspective view in which the actuator of FIG. 1 is partially closed;

FIG. 3 is a raised side view of the actuator of FIGS. 1 and 2, closed;

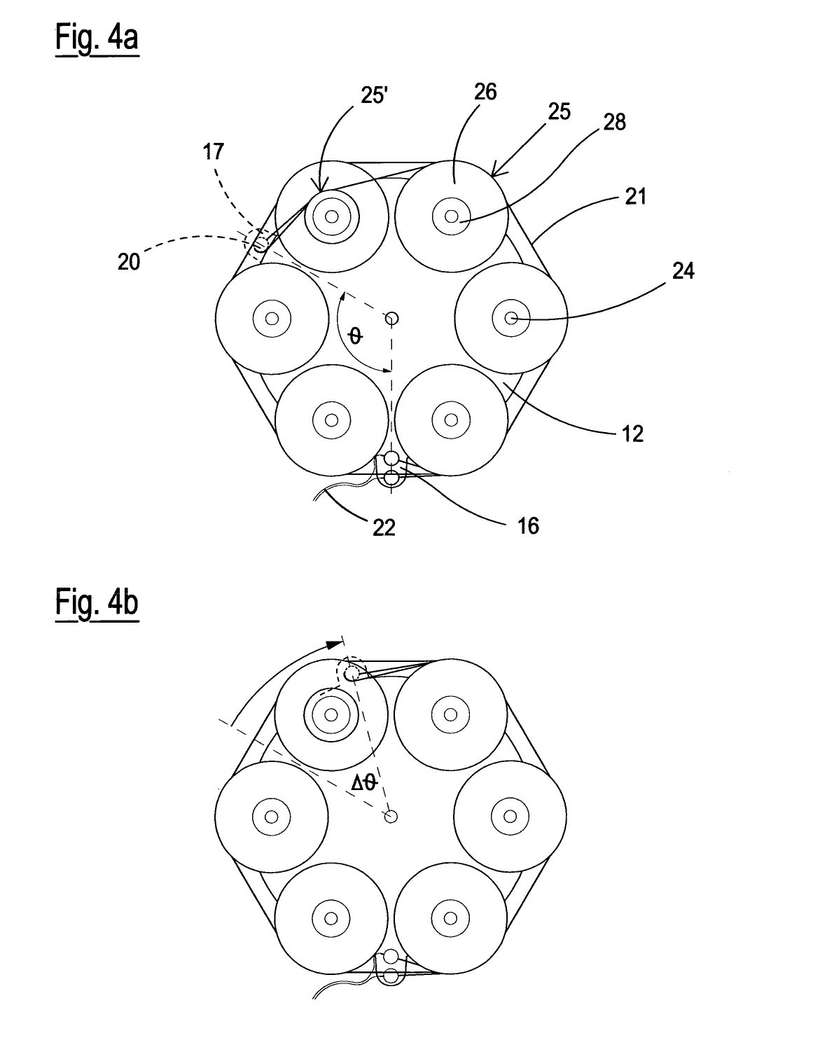

FIGS. 4a and 4b are plan views of the internal part of the actuator shown in FIGS. 1-3 in two different operative phases;

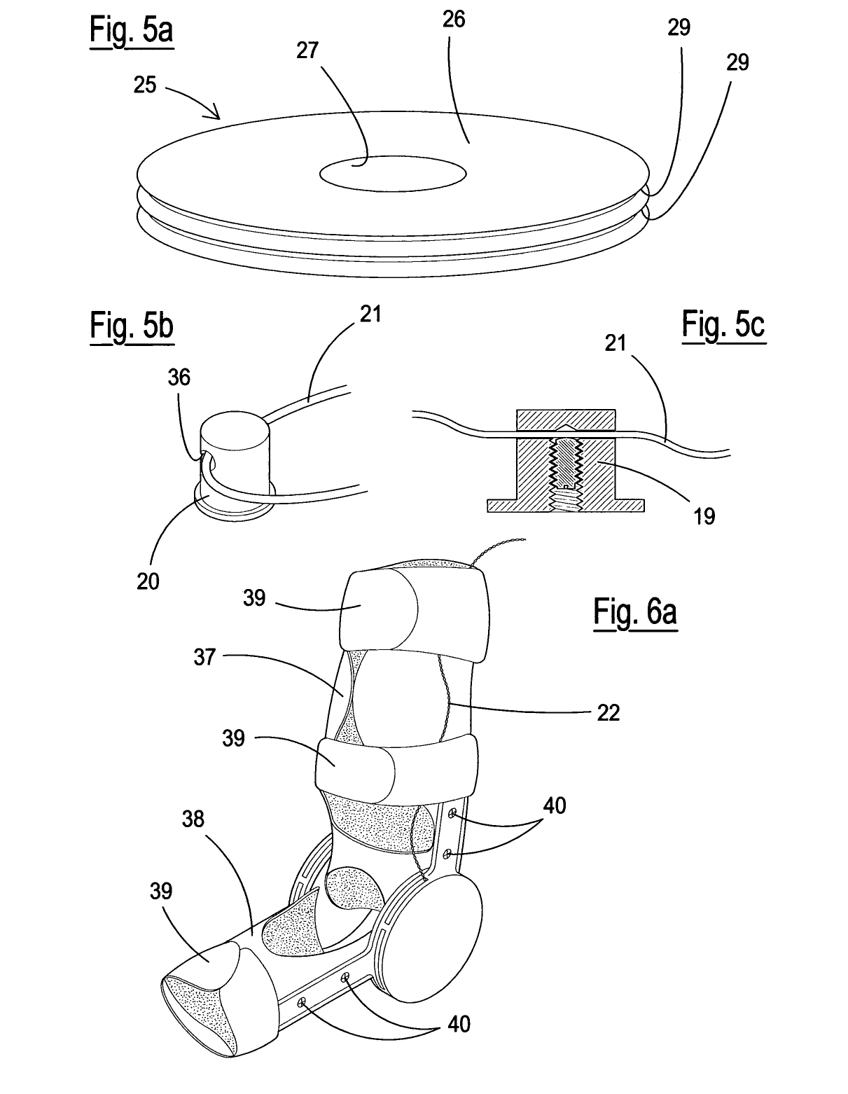

FIGS. 5a, 5b and 5c show in a full or sectional view, enlarged details forming part of the actuator of FIGS. 1-4b;

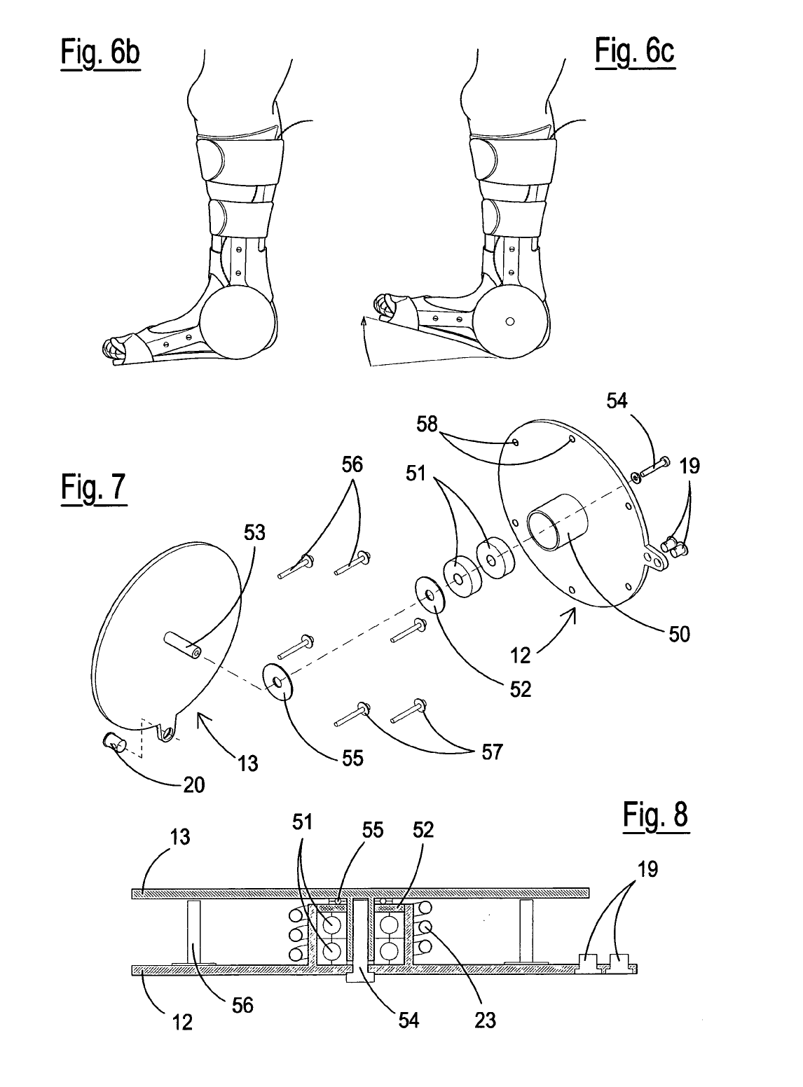

FIG. 6a shows a perspective view of an application of a pair of actuators according to FIGS. 1-5b to an orthosis for an ankle;

FIGS. 6b and 6c show further perspective views of the orthosis of FIG. 6 in different activation phases of the actuators;

FIG. 7 is an exploded schematic perspective view of a further embodiment of a rotational actuator according to the present invention;

FIG. 8 is an enlarged sectional view of a detail of the actuator of FIG. 7 assembled;

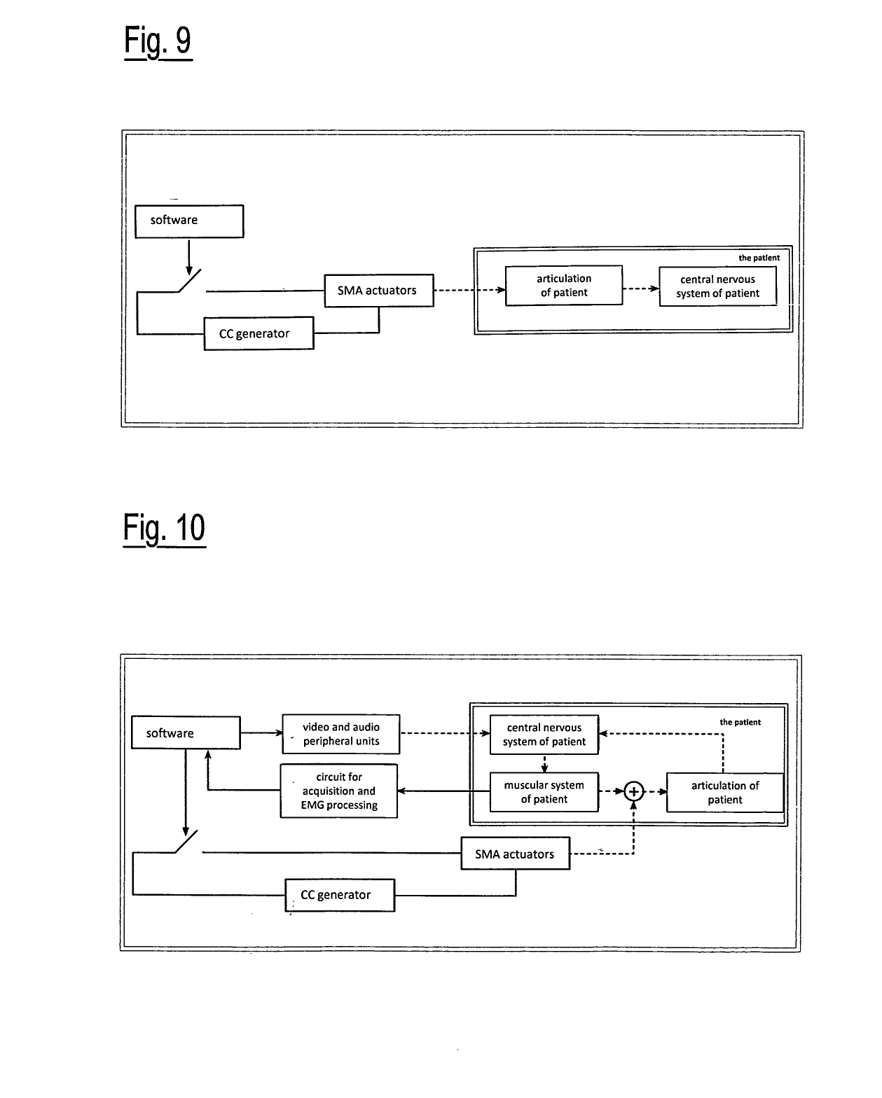

FIGS. 9 and 10 describe two functioning modes of an actuator applied to an orthosis mounted on an ankle.

With reference first of all to FIGS. 1-3, these illustrate in an exploded schematic perspective view, a perfected rotational actuator according to the present invention, indicated with 11.

The actuator 11 in the example is composed of different parts, all made of non-magnetic materials.

Two metal plates 12 and 13 are connected to the centre by a metallic pin 14, wedged into the plate 12 and free to rotate in an non-magnetic ball bearing 15 inserted in the plate 13. The two plates 12 and 13 each have a circular shape, respectively with a tooth 16 and 17 protruding radially and outwardly and perforated; in particular, the tooth 16 of the plate 12 comprises two holes 18 and the tooth 17 of the plate 13 only one hole 18. Two non-conductive elements 19 are inserted into these holes 18 of the tooth 16 of the plate 12, which serve to fix the ends of a shape memory alloy (SMA) wire 21 (FIG. 5c). A non-conductive element 20 is inserted into the hole 18 of the tooth 17 of the plate 13 to create a movable constraint between an intermediate portion of the wire 21 and the plate 13 (FIG. 5b).

The electric contact is created by crimping an electric wire 22 at the ends of the shape memory alloy wire 21 which both protrude from the two non-conductive elements 19 onto the plate 12. All the elements 19, 20 also have the purpose of electrically insulating the shape memory alloy wire 21 from the plates 12 and 13.

A torque spring 23 is wound around the pin 14, which generates a slight torque when the two plates 12 and 13 are rotated with respect to each other. This spring 23 has the purpose of keeping the shape memory alloy wire 21 taut in whatever point of the run the actuator 11 may be. A further six metallic pins 24 are also wedged onto the plate 12, which describe a hexagon centred on the pin 14 (see FIG. 1). These pins 24 have such a length as to slide with minimum friction on the surface of the plate 13, when the pin 14 is wedge-inserted at both ends. A variable number of pulleys 25 (two or three) are inserted on each of these pins 24, produced by a body 26 made of non-conductive plastic at whose centre a non-magnetic ball bearing 28 is wedge-inserted in a hole 27. The body 26 of each pulley 25 is a plastic disk perforated at the centre with two adjacent triangular slots 29 which occupy the whole of its thickness covering the whole circumference (see FIG. 5a). It is essential for there to be two slots 29 as the two segments of wire 21 resting in their interior have a different electric potential.

The number of pulleys 25 is variable in relation to the pin 24 on which they are inserted. In addition to the pulleys 25, shims 30 are also inserted on the six pins 24, which serve to attenuate the passage between the slots 29 of two consecutive pulleys 25.

These shims 30 are inserted under the pulleys 25 in an increasing number according to the winding direction of the wire 21. A last pulley 25′ along which the wire 21 runs before passing through the element 20 on the plate 13 is smaller than the other pulleys 25, but has the same disk design with a central hole for the bearing 28 and the double circumferential slot 29.

Each of the plates 12 and 13 is wedge-inserted (or glued, or screwed) onto one of two plastic box-shaped shells 31 and 32 which electrically isolate all the components from the outside. The shell 31 is flat, whereas the shell 32 has a thickness and is in the form of a cylinder. The shell 32 is such as to contain all the internal mechanism and be perfectly closed with the shell 31 and has, for the whole of its thickness, openings 33 which favour the cooling of the wire 21.

FIG. 3 illustrates better the arrangement of the rotational actuator 11, shown in an exploded view in FIG. 1, once assembled in the shells 31 and 32.

It can thus be seen that the pin 14 connects the two plates 12 and 13, whereas the pulleys 25, the shims 30 and the final pulley 25′ are inserted in the pins 24 (not visible) wedge-inserted in the plate 12. There are a different number of shims 30 on different pins 24 to distance the pulleys 25 in an axial direction and favour the passage of the wire 21 from the slot of one pulley 25 to that of the corresponding pulley 25 on the consecutive shaft 24. The shape memory alloy wire 21 runs along a helix around the pulleys 25, is inserted in a hole 36 of the element 20 visible and returns passing again along the pulleys 25. When the NiTi wire 21 recuperates its form, it exerts a force on this element 20. The element 20 is wedge-inserted in a shaped hole 18 of the tooth 17 in the plate 13; the plate 13 does not have any constraint with the rest of the structure except for the central pin 14, and consequently the force applied to the element 20 produces a relative rotation of the plate 13 with respect to the plate 12 and to the rest of the structure integral therewith (i.e. the pins 24 and all the elements inserted therein). The final pulley 25′ has a smaller diameter than that of the pulleys 25 so as to not hinder the rotation of the element 20 around the central pin 14 which acts as axis. Only the pin 24, which is the last to be crossed by the wire, has the pulley 25′ in substitution of the usual pulley 25 in the position nearest to the plate 13.

Both of the shells 31 and 32 have a radial arm 34 and 35 facing outwards, to which other elements to which the relative rotation motion must be transmitted, can be connected.

The actuator 11 described so far has been designed for being able to house a large quantity of SMA wire 21, which is the true “motor” of the device. Starting from the innermost element 19 on the tooth 16 of the plate 12, the wire 21 passes along a helix in one direction resting on the lower slot 29 of each pulley 25, until it reaches the element 20 on the plate 13 (not shown in FIGS. 4a, 4b). Passing through a hole 36 in the element 20, the wire 21 is constrained for half of its length and returns back following the same route, but this time resting inside the upper slot 29 of each pulley 25.

When the wire 21 recuperates its form, on becoming shorter it produces the rotation of the movable constraint in a clockwise direction with respect to the central pin 14.

Once the wire 21, on cooling, returns to martensite, it is possible to return to the initial configuration by applying an external force to the system. The spring 23 (not represented in FIGS. 4a, 4b) positioned around the pin 14 applies a slight torque which keeps the wire taut inside the slot of the pulleys 25.

The length of the wire 21 depends on the dimensions of the components and initial angle between the teeth 16 and 17 of the plates 12 and 13 in a plan view (see FIG. 4a).

If R is the distance between the rotation centre of the actuator and the centre of the pulley, D the diameter of the pulley, n the number of complete revs (in this configuration 2) and θ the angle between the teeth 16, 17, the length of a helix of the wire 21 (in martensite) is approximately

$$L = 6 \cdot ( R + D \cdot \frac{π}{6} ) \cdot ( n + \frac{2 π - θ}{2 π} )$$

From the same formula, it is possible to estimate the angular run AO of the actuator when the wire 21 is transformed into austenite, being shortened by ΔL. The total length of the wire contained in the actuator, on the other hand is 2L.

Once it has been heated to above the transformation temperature, the shape memory alloy wire 21 generates a recovery force Fr which in the configuration proposed, is converted to a torque Cr equal to

$${C}_{r} = 2 {F}_{r} \cdot ( \frac{\sqrt{3}}{2} \cdot R + \frac{1}{2} \cdot D )$$

The actuator 11 proposed is therefore optimized for generating high torques with relatively thin wires. The design proposed, with the same outgoing torque, allows the use of a wire having a diameter about 70% of that in a single-winding configuration. This allows the cooling times to be reduced by approximately 30%, significantly accelerating the operating cycle.

The Joule effect is the simplest and most common way for controllably transferring thermal power to a wire element 21. The actuator proposed in this document also exploits the same principle. Any current which passes along a conductor produces a magnetic field, but the particular design of this actuator allows most of this to be limited. The wire 21 is in fact forced to follow a trajectory which describes two concentric helixes inside the actuator. The magnetic field generated by each of the two helixes is perfectly the same in the module but has an opposite sign due to the different winding direction of the two helixes. The concentricity of the two helixes and the fact that the wire is the same leads to the compensation of the two fields, generating a null field externally.

This is the key element which allows the use of the actuator in the application: i.e. the double concentric helix which allows the net magnetic field generated by the actuator to be nullified, making it non-magnetic as a whole.

A rotational actuator with a shape memory thus conceived can also be applied in all fields in which the magnetic compatibility of the device is essential.

The actuator 11 proposed can also be produced with materials which are not non-magnetic. This makes it unsuitable for all applications with restrictions relating to non-magneticity but it allows the use of materials which have a higher performance for specific applications. All the other advantages deriving from the design of the actuator remain valid, among which the high outgoing torque.

Another obvious modification relates to the number of windings of the double helix along the hexagonal trajectory. This has the effect of increasing the angular run Δθ available according to the formula described above.

Further modifications to the actuator proposed can comprise several wires which run parallelly, describing a double helix. This allows the outgoing torque to be proportionally increased. In this sense, the modifications brought relate to at least the number of slots per pulley and the length of the pins or shafts 14 and 24.

FIGS. 6a-6c show the possible use of an actuator according to the present invention.

The use of this actuator for the movement of the limbs envisages the construction of an orthosis around an articulation to which one or two actuators 11 are laterally constrained. This interface between the actuator and human body must ensure the stability of the limb (this aspect belongs again to common practice) and guarantee that the rotation axis of the actuators coincides with the rotation axis of the articulation.

In the application shown of rotational actuators to an orthosis of an ankle, the orthosis is composed of a proximal valve 37 positioned in front of the tibia and a valve 38 positioned on the foot. The two valves 37, 38 are hinged to each other at the level of the ankle and connected to the human body by means of Velcro strips 39.

The actuators 11, charged through the electric wires 22, are constrained to the valves 37, 38 by means of screws (or rivets) 40 positioned on the arms 34 and 35. Other embodiments are possible, for example with other types of valves and/or which are positioned behind the calf or on the sole of the foot.

The possibility of assembling the actuator in two ways, i.e. with the arm 35 of the shell 32 either on the distal or proximal segment of the body and the arm 34 of the shell 31 accordingly, enables the whole encumbrance of the actuator 11 to be kept externally with respect to the limb, facilitating its assembly.

FIGS. 6a-6c show an implementation example for the ankle.

The control of the actuator 11 is effected according to the schemes shown in FIGS. 9 and 10, which describe two functioning modes.

In the passive mode shown in FIG. 9, the program is established by the therapist according to a fixed sequence of repetitions. The computer controls a switch which closes the actuator-feeder circuit in a temporized manner.

In the active-assisted mode of FIG. 10, the orthosis-patient system describes a closed circuit.

The patient receives instructions (video and audio) for producing the movement to be practised. The EMG activity of the muscle which controls this movement is revealed. After being amplified, rectified and filtered (passing band 18-450 Hz) the EMG signal is compared with two patient-specific reference values established by the therapist. The lowest value represents the minimum contraction the subject can control (generally not yet sufficient for effectively moving the limb); the highest value represents the level beyond which the movement is effected autonomously in a complete manner. If the EMG signal treated does not reach the minimum level, the feedback to the patient is negative and the subject is encouraged to make a greater effort. Between the minimum and maximum threshold, the EMG activity of the patient is insufficient for completing the movement: the subject receives a positive feedback and is encouraged to continue the contraction while the orthesis is activated to allow the movement to be completed. If the contraction of the muscle is such as to bring the treated EMG signal beyond the highest threshold, the orthosis is not activated but the subject receives a positive feedback.

FIGS. 7 and 8 show a further embodiment of a rotational actuator according to the present invention.

In this second example, in which the same elements are indicated with the same numbers, the plate 12 has a central neck 50 in which two ball bearings 51 and a plastic cylinder 52 are housed. The plate 13 has a neck with a smaller diameter 53 which is inserted in the central hole of the bearings 51 and the cylinder 52. A screw 54 is inserted behind the plate 12 and is screwed into the centre of the neck 53 of the plate 13. A thrust bearing 55 is inserted around the neck 53 of the plate 13 and creates a friction-free sliding interface between the plate 13 and the system composed of the plate 12, the bearings 51 and the cylinder 52. Pins 56 have the shape of an enlarged collar 57 which rests on the plate 12 when the same pins 56 are wedge-inserted into radial holes 58 on the plate 12. The assembly method of the shape memory alloy wire, the pulleys, the central spring, the outer elements or shells 31 and 32 made of plastic and the elements 19 and 20 for gripping the wire 21 remain unvaried with respect to the previous embodiment and have been omitted from the drawing for greater clarity.

FIG. 8 is a sectional view of a cross-section of this second embodiment proposed for the rotational actuator. The axial coupling between the plates 12 and 13 is produced by means of the screw 54 and the thrust bearing 55 and, whereas the relative rotation is enabled by the bearings 51 and thrust bearing 55. This coupling system allows a greater stability with respect to the flexion.

The objective indicated in the preamble of the description has therefore been achieved.

The forms of the structure for the production of a rotational actuator of the invention, as also the materials and assembly modes, can naturally differ from those shown for purely illustrative and non-limiting purposes in the drawings.

The protection scope of the invention is therefore delimited by the enclosed claims.

1. A perfected rotational actuator, comprising, in two box-shaped shells (31, 32), a pair of plates (12, 13) connected to each other by a central pin (14) and containing a plurality of pulleys (25), with two superimposed perimetric slots (29), in which a shape-memory wire (21) circulates, wherein two segments of said wire (21) are arranged in aligned slots (29) of the pulleys (25) and are constrained at opposite ends to non-conductive elements (19) integral with a tooth (16) protruding radially from a plate (12) and in a position shifted by a certain angle (Θ) with respect to each other, said two segments of wire being defined by passage through a further non-conductive element (20) integral with a tooth (17) radially protruding from the second plate (13), a torque spring (23) situated on said central pin (14) being interposed between said plates (12, 13), said opposite ends of said wire (21) being connected to an electric wire (22), radial arms (34, 35) of each of said shells (31, 32) being connected to elements to which the rotation movement is to be transmitted.

2. The rotational actuator according to claim 1, characterized in that each of said pulleys (25) comprises a non-conductive body (26), at whose centre a bearing (28) is fixed in a hole (27).

3. The rotational actuator according to claim 1, characterized in that said pulleys (25) are arranged, in a variable number, on pins (24) situated between said two plates (12,13) on which they slide with minimum friction.

4. The rotational actuator according to claim 1, characterized in that said pulleys (25) are arranged according to a hexagon centred on said central pin (14) between said plates (12, 13).

5. The rotational actuator according to claim 1, characterized in that all the components of said actuator are made of a non-magnetic material, said wire (21) having a concentric double helix design which allows the net magnetic field generated by the actuator to be nullified.

6. The rotational actuator according to claim 1, characterized in that shims (30) are inserted between said plates (12, 13) and said pulleys (25) to align slots (29) of subsequent pulleys on which the segments of said wire (21) pass.

7. The rotational actuator according to claim 1, characterized in that said central pin comprises a neck (50) extending from a plate (12) in which a neck, having a smaller diameter (53), is inserted, which extends from the other plate (13), bearings (51) being interposed.

8. The rotational actuator according to claim 7, characterized in that said pulleys are arranged on pins (56) having a shape which includes enlarged collar (57) which rests on the plate (12) with ns (56) inserted therein.
